(19) United States
(12) Patent Application Publication
(10) Pub. No.: US 2008/0082219 A1
(43) Pub. Date: Apr. 3, 2008

(54) Heat sink system management

(76) Inventors: Christian L. Belady, Richardson, TX (US); Mark E. Shaw, Richardson, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/540,118

(22) Filed: Sep. 29, 2006

(51) Int. Cl. G05D 23/00

(52) U.S. Cl. 700/300

(57) ABSTRACT

In one embodiment, a computing system comprises one or more processors and a memory module communicatively connected to the one or more processors. The memory module comprises logic instructions which, when executed on the one or more processors configure the one or more processors to activate a primary heat sink system, monitor the status of the primary heat sink system, and activate a secondary heat sink system when the primary heat sink system fails to meet an operational parameter.

### TECHNICAL FIELD

This application relates to electronic computing and more particularly to heat sink system management.

### BACKGROUND

Computing devices such as personal computers (PCs) typically include one or more printed circuit boards (PCBs) on which various components are mounted to form printed circuit assemblies (PCAs). Such components include those that generate heat during their operation. One type of component that often generates large quantities of heat is a microchip, such as a microprocessor.

Due to the great heat generated by some components, heat sinks are sometimes employed to remove heat from the components and transfer that heat to the ambient air that surrounds the components. For example, it is common to mount heat sinks to microprocessors to transfer heat generated by the microprocessors during their operation. In some cases, heat sinks can malfunction, which can cause operational errors to occur due to overheating of the component. Therefore, it may be important to ensure that a given heat sink is operational.

### SUMMARY

In one embodiment, a computing system comprises one or more processors and a memory module communicatively connected to the one or more processors. The memory module comprises logic instructions which, when executed on the one or more processors configure the one or more processors to activate a primary heat sink system, monitor the status of the primary heat sink system, and activate a secondary heat sink system when the primary heat sink system fails to meet an operational parameter.

### BRIEF DESCRIPTION OF THE DRAWINGS

FIG. 1 is a schematic illustration of one embodiment of a computing system adapted to implement heat sink system management.

FIG. 2 is a schematic depiction of a circuit board assembly including a heat sink.

FIG. 3 is a flowchart illustrating operations in one embodiment of a method of operating a computing system adapted to implement heat sink system management.

FIG. 4 is a schematic illustration of a computing environment in accordance with an embodiment.

### DETAILED DESCRIPTION

Disclosed are systems and methods for heat sink system management which reduce the likelihood of overheating of a heat-producing component of a computing device.

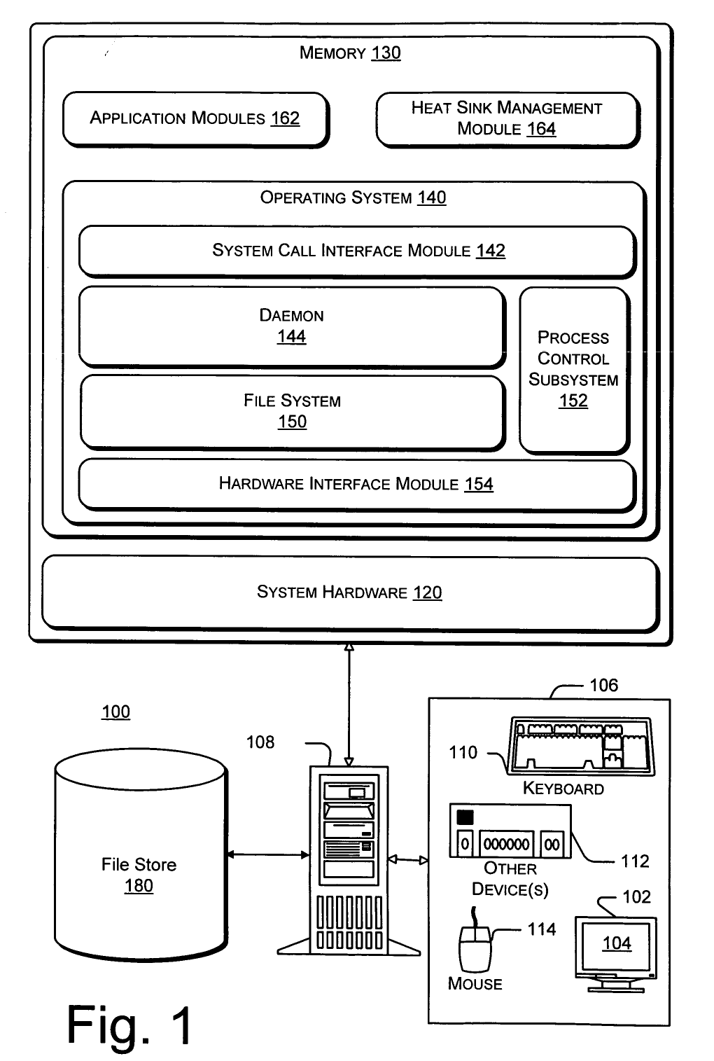

FIG. 1 is a schematic illustration of an exemplary computer system 100 adapted to perform heat sink system management. In one embodiment, the computer system 100 includes a computer 108 and one or more accompanying input/output devices 106 including a display 102 having a screen 104, a keyboard 110, other I/O device(s) 112, and a mouse 114. The other device(s) 112 can include a touch screen, a voice-activated input device, a track ball, and any other device that allows the system 100 to receive input from a developer and/or a user. The computer 108 includes system hardware 120 and random access memory and/or read-only memory 130. A file store 180 is communicatively connected to computer 108. File store 180 may be internal such as, e.g., one or more hard drives, or external such as, e.g., one or more external hard drives, network attached storage, or a separate storage network.

Memory 130 includes an operating system 140 for managing operations of computer 108. In one embodiment, operating system 140 includes a hardware interface module 154 that provides an interface to system hardware 120. In addition, operating system 140 includes one or more file systems 150 that manage files used in the operation of computer 108 and a process control subsystem 152 that manages processes executing on computer 108. Operating system 140 further includes a system call interface module 142 that provides an interface between the operating system 140 and one or more application modules 162 and a heat sink management module 164.

The particular embodiment of operating system 140 is not critical to the subject matter described herein. Operating system 140 may be embodied as a UNIX operating system or any derivative thereof (e.g., Linux, Solaris, etc.) or as a Windows® brand operating system.

In operation, one or more application modules 162 and/or libraries 164 executing on computer 108 make calls to the system call interface module 142 to execute one or more commands on the computer's processor. The system call interface module 142 invokes the services of the file system(s) 150A to manage the files required by the command(s) and the process control subsystem 152 to manage the process required by the command(s). The file system 150 and the process control subsystem 152, in turn, invoke the services of the hardware interface module 154 to interface with the system hardware 120.

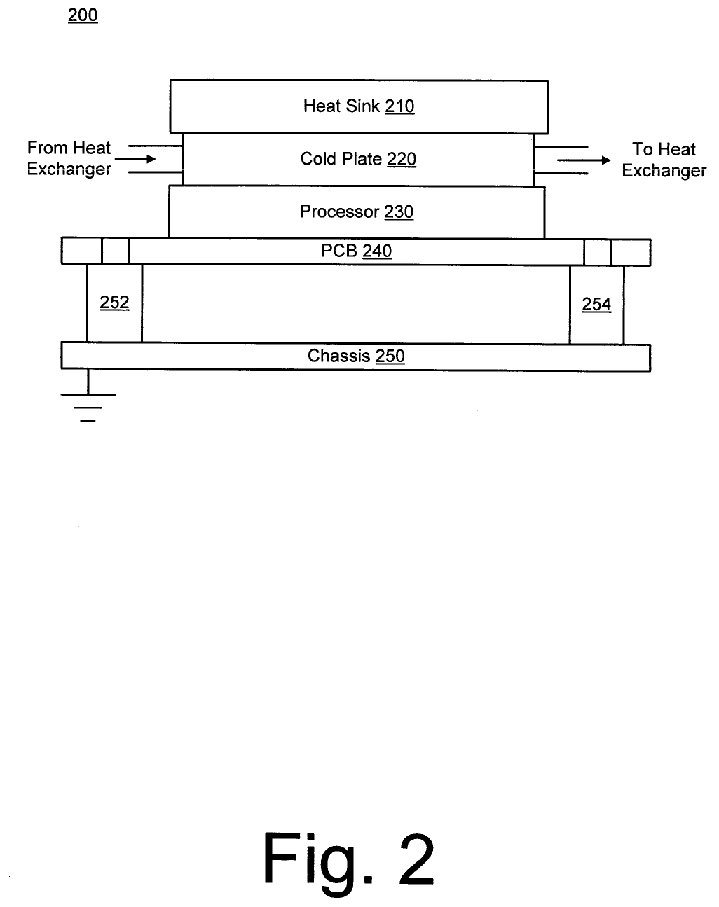

FIG. 2 is a schematic depiction of one embodiment of a circuit board assembly 200 including a heat sink system. Referring to FIG. 2, circuit board assembly 200 comprises a printed circuit board (PCB) 240 mounted to an underlying chassis 250. Chassis 250 may include one or more mounting brackets 252, 254, also referred to as standoffs, to which the PCB 240 may be connected. In alternate embodiments, the PCB 240 may be on slides and connect to a backplane.

PCB 240 may include a plurality of components such as, e.g., processors, memory, etc., connected by circuit traces on the PCB 240. In one embodiment, PCB 240 may include a heat generating component such as processor 230 mounted to the surface of PCB 240.

Circuit board assembly 200 may further include a cold plate 220 coupled to the processor 230. In one embodiment, cold plate 220 may receive cooled fluid such as, e.g., water or oil, air or compressed gas, from a heat exchange assembly. The cooled fluid may be circulated through cold plate 220 to transfer heat from processor 230 and forwarded to the heat exchange assembly. In the heat exchange assembly, heated fluid may be cooled using a radiator, fan or other heat transfer mechanisms.

Circuit board assembly 200 may further include a heat sink 210. Heat sink 210 may be mounted in thermal communication with a heat-generating component such as processor 230 such that heat generated by processor 230 may be transferred from the processor 230 to the heat sink 210, which dissipates the heat. In one embodiment, heat sink 210 may be mounted to cold plate 220. In alternate embodiments, heat sink 210 may be in direct physical contact with processor 230. Heat sink 210 may be embodied as an air cooled heat sink. Heat sink 210 may include one or more fans to actively dissipate heat generated by processor. Alternatively, heat sink 210 may passively dissipate heat. In alternate embodiments the components may be assembled in a different order. For example, the heat sink 210 may be disposed between the cold plate 220 and the processor 230.

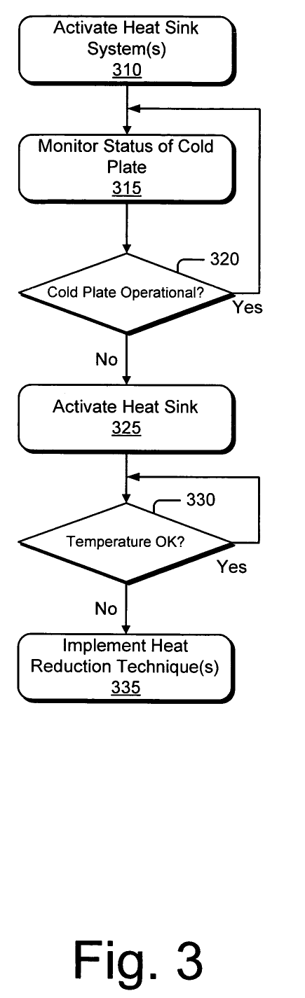

Referring back to FIG. 1, in one embodiment heat sink management model 164 implements logic instructions which, when executed, configure the processor to manage one or more heat sink systems in the computer system 100. In one embodiment, the logic instructions may be incorporated into the basic input/output system (BIOS) of a computing device. In an alternate embodiment, the logic instructions may be stored in the memory module 130 of computing system 100 and executed periodically as a background process. FIG. 3 is a flowchart illustrating operations in one embodiment of a heat sink management module.

Referring to FIG. 3, at operation 310, the heat sink system(s) are activated. In one embodiment, the heat sink system(s) may be activated by the computer system's Basic Input/Output System (BIOS) when the computer system is booted. At operation 315 the operational status of the cold plate 220 is monitored.

If, at operation 320 the cold plate 220 is operational, then control passes back to operation 315 and the computer system 100 may continue normal operations while the status of the cold plate 220 is monitored. In one embodiment, the cold plate 220 may be considered operational if the fluid coolant circuit associated with the cold plate 220 is operational. In alternate embodiments the cold plate 220 may be considered operational if the cold plate 220 operates to maintain the temperature of the processor below a threshold. The threshold may be static (e.g., an absolute temperature or percentage of a maximum temperature threshold associated with the processor) or dynamic.

By contrast, if at operation 320 the cold plate 220 is not operational, then control passes to operation 325 and the heat sink 210 is activated. For example, activating heat sink 210 may be activated by turning one at least one fan associated with heat sink 210. If, at operation 330, the operating temperature of the processor 230 is acceptable, then the computer system 100 may continue normal operations. By contrast, if at operation 330 the temperature of the processor is not acceptable, i.e., if the temperature exceeds an upper threshold, then control passes to operation 335 and one or more heat reduction techniques may be implemented. For example, the operating speed of the processor may be reduced or the processor may be completely shut down.

In alternate embodiments, the cold plate 220 and heat sink 210 may both be operational during normal operations of computer system 100. In such embodiments, the operation 325 of activating the heat sink 210 need not be implemented.

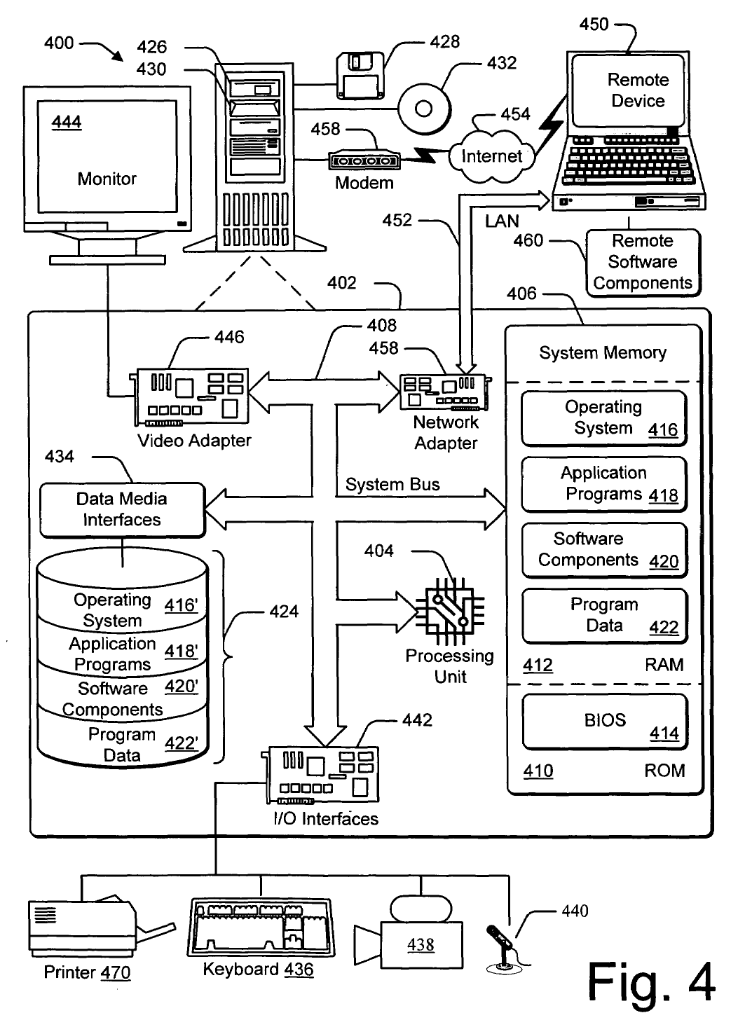

In one embodiment, the PCB assembly 200 depicted in FIG. 2 may be incorporated into a computing system. FIG. 4 shows components of typical example of such a computer, referred by to reference numeral 400. The components shown in FIG. 4 are only examples, and are not intended to suggest any limitation as to the scope of the functionality of the invention; the invention is not necessarily dependent on the features shown in FIG. 4.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The functionality of the computers is embodied in many cases by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions, programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 4, the components of computer 400 may include, but are not limited to, a processing unit 404, a system memory 406, and a system bus 408 that couples various system components including the system memory 406 to the processing unit 404. The system bus 408 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus.

Computer 400 typically includes a variety of computer-readable media. Computer-readable media can be any available media that can be accessed by computer 400 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 400. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network, fiber optic networks, or direct-wired connection and wireless media such as acoustic, RF, infrared and other wireless media. Combinations of any of the above should also be included within the scope of computer readable media

The system memory 406 includes computer storage media in the form of volatile and/or nonvolatile memory such as read only memory (ROM) 410 and random access memory (RAM) 412. A basic input/output system 414 (BIOS), containing the basic routines that help to transfer information between elements within computer 400, such as during start-up, is typically stored in ROM 410. RAM 412 typically contains data and/or program modules that are immediately accessible to and/or presently being operated on by processing unit 404. By way of example, and not limitation, FIG. 4 illustrates operating system 416, application programs 418, other software components 420, and program data 422.

The computer 400 may also include other removable/non-removable, volatile/nonvolatile computer storage media. By way of example only, the computer system of FIG. 4 may include a hard disk drive 424 that reads from or writes to non-removable, nonvolatile magnetic media, a magnetic disk drive 426 that reads from or writes to a removable, nonvolatile magnetic disk 428, and an optical disk drive 430 that reads from or writes to a removable, nonvolatile optical disk 432 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 424 is typically connected to the system bus 408 through a non-removable memory interface such as data media interface 434, and magnetic disk drive 426 and optical disk drive 430 are typically connected to the system bus 408 by a removable memory interface.

The drives and their associated computer storage media discussed above and illustrated in FIG. 4 provide storage of computer-readable instructions, data structures, program modules, and other data for computer 400. In FIG. 4, for example, hard disk drive 424 is illustrated as storing operating system 416′, application programs 418′, software components 420′, and program data 422′. Note that these components can either be the same as or different from operating system 416, application programs 418, software components 420, and program data 422. Operating system 416, application programs 418, other program modules 420, and program data 422 are given different numbers here to illustrate that, at a minimum, they are different copies. A user may enter commands and information into the computer 400 through input devices such as a keyboard 436 and pointing device 438, commonly referred to as a mouse, trackball, or touch pad. Other input devices (not shown) may include a microphone 440, joystick, game pad, satellite dish, scanner, or the like. These and other input devices are often connected to the processing unit 404 through an input/output (I/O) interface 442 that is coupled to the system bus, but may be connected by other interface and bus structures, such as a parallel port, game port, or a universal serial bus (USB). A monitor 444 or other type of display device is also connected to the system bus 406 via an interface, such as a video adapter 446. In addition to the monitor 444, computers may also include other peripheral output devices (e.g., speakers) and one or more printers 470, which may be connected through the I/O interface 442.

The computer may operate in a networked environment using logical connections to one or more remote computers, such as a remote computing device 450. The remote computing device 450 may be a personal computer, a server, a router, a network PC, a peer device or other common network node, and typically includes many or all of the elements described above relative to computer 400. The logical connections depicted in FIG. 4 include a local area network (LAN) 452 and a wide area network (WAN) 454. Although the WAN 454 shown in FIG. 4 is the Internet, the WAN 454 may also include other networks. Such networking environments are commonplace in offices, enterprise-wide computer networks, intranets, and the like.

When used in a LAN networking environment, the computer 400 is connected to the LAN 452 through a network interface or adapter 456. When used in a WAN networking environment, the computer 400 typically includes a modem 458 or other means for establishing communications over the Internet 454. The modem 458, which may be internal or external, may be connected to the system bus 406 via the I/O interface 442, or other appropriate mechanism. In a networked environment, program modules depicted relative to the computer 400, or portions thereof, may be stored in the remote computing device 450. By way of example, and not limitation, FIG. 4 illustrates remote application programs 460 as residing on remote computing device 450. It will be appreciated that the network connections shown are exemplary and other means of establishing a communications link between the computers may be used.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least one implementation. The appearances of the phrase “in one embodiment” in various places in the specification are not necessarily all referring to the same embodiment.

Although some embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method of managing heat sink systems, comprising:
activating, in an electronic device, a primary heat sink system;
monitoring the status of the primary heat sink system; and
activating a secondary heat sink system when the primary heat sink system fails to meet an operational parameter.

2. The method of claim 1, wherein the primary heat sink system comprises:
a cold plate; and
a fluid coolant circuit in fluid communication with the cold plate a heat exchanger.

3. The method of claim 2, wherein monitoring the status of the primary heat sink system comprises monitoring the operation of the fluid coolant circuit.

4. The method of claim 2, wherein monitoring the status of the primary heat sink system comprises monitoring a temperature parameter proximate the primary heat sink system.

5. The method of claim 1, wherein activating a secondary heat sink system when the primary heat sink system fails to meet an operational parameter comprises activating an air flow heat sink when the primary heat sink system fails.

6. The method of claim 1, wherein activating a secondary heat sink system when the primary heat sink system fails to meet an operational parameter comprises activating an air flow heat sink when the primary heat sink system fails to maintain an adequate temperature in a location proximate the primary heat sink system.

7. The method of claim 1, further comprising implementing one or more heat reduction techniques when the secondary heat sink system fails to maintain an adequate temperature in a location proximate the primary heat sink system.

8. The method of claim 1, wherein the secondary heat sink system comprises:
a cold plate; and
a fluid coolant circuit in fluid communication with the cold plate a heat exchanger.

9. A computing system, comprising:
one or more processors;
a memory module communicatively connected to the one or more processors and comprising logic instructions which, when executed on the one or more processors configure the one or more processors to:
activate a primary heat sink system;
monitor the status of the primary heat sink system; and
activate a secondary heat sink system when the primary heat sink system fails to meet an operational parameter.

10. The computing system of claim 9, wherein the primary heat sink system comprises:
a cold plate; and
a fluid coolant circuit in fluid communication with the cold plate a heat exchanger.

11. The computing system of claim 10, further comprising logic instructions which, when executed, configure the processor to monitor the operation of the fluid coolant circuit.

12. The computing system of claim 10, further comprising logic instructions which, when executed, configure the processor to monitor a temperature parameter proximate the primary heat sink system.

13. The computing system of claim 9, further comprising logic instructions which, when executed, configure the processor to activate an air flow heat sink when the primary heat sink system fails.

14. The computing system of claim 9, further comprising logic instructions which, when executed, configure the processor to activate an air flow heat sink when the primary heat sink system fails to maintain an adequate temperature in a location proximate the primary heat sink system.

15. The computing system of claim 9, further comprising logic instructions which, when executed, configure the processor to implement one or more heat reduction techniques when the secondary heat sink system fails to maintain an adequate temperature in a location proximate the primary heat sink system.

16. The computing system of claim 9, further comprising one or more additional heat sinks or cold plates.

17. A computer program product stored on a computer-readable medium comprising logic instructions which, when executed on a processor, configure the processor to:
activate a primary heat sink system in an electronic device;
monitor the status of the primary heat sink system; and
activate a secondary heat sink system in the electronic device when the primary heat sink system fails to meet an operational parameter.

18. The computer program product of claim 17, further comprising logic instructions which, when executed, configure the processor to monitor a temperature parameter proximate the primary heat sink system.

19. The computer program product of claim 17, further comprising logic instructions which, when executed, configure the processor to activate the secondary heat sink system when the primary heat sink system fails.

20. The computer program product of claim 17, further comprising logic instructions which, when executed, configure the processor to activate an air flow heat sink when the primary heat sink system fails to maintain an adequate temperature in a location proximate the primary heat sink system.

21. The computer program product of claim 17, further comprising logic instructions which, when executed, configure the processor to implement one or more heat reduction techniques when the secondary heat sink system fails to maintain an adequate temperature in a location proximate the primary heat sink system.
